(19) United States
(12) Patent Application Publication
(10) Pub. No.: US 2025/0231845 A1
(43) Pub. Date: Jul. 17, 2025

(54) STORAGE SYSTEM THAT REALLOCATES VOLUMES BASED ON THEIR IMPORTANCE

(71) Applicant: HITACHI, Ltd., Tokyo (JP)

(72) Inventors: Takanobu SUZUKI, San Jose, CA (US); Tomohiro KAWAGUCHI, Santa Clara, CA (US)

(21) Appl. No.: 18/409,852

(22) Filed: Jan. 11, 2024

(51) Int. Cl. G06F 11/20

(52) U.S. Cl. CPC G06F 11/2053; G06F 11/2094

(57) ABSTRACT

Systems and methods described herein can involve, for a detection of a failure of a component from the one or more components, determining an amount of free space required to restore redundancy from an amount of data stored in the failed component; determining ones of the one or more volumes that can be migrated to the another storage system based on the importance information indicating that data of the determined ones of the one or more volumes can be stored in the another storage system; determining a combination of the determined ones of the one or more volumes that satisfy the amount of free space required based on capacity information of the determined ones of the one or more volumes; and migrating the determined combination of the determined ones of the one or more volumes to the another storage system to restore redundancy.

### BACKGROUND

### Field

The present disclosure generally relates to storage systems, and more specifically, to volume reallocation.

### Related Art

In the related art, the number of skilled information technology (IT) administrators has been decreasing, and there is a need to ensure that storage can be operated stably even by administrators with limited expertise.

In addition, as cloud computing has become more common, the style of operation has also become more cloud-like. “Cloud-like” means that users define the service level when they contract with service providers. Service providers should operate in accordance with service levels.

In the event of a resource storage in the storage system, such as in the event of hardware failure, there is a need to achieve stable operation automatically by temporarily evacuating those volumes that have little impact on the service level to the cloud and reallocating resources to those remaining volumes in on-premise.

FIG. 1 illustrates an example related art implementation to move data to the cloud. In the related art, there are systems and methods to determine and move data to the cloud based on Input/Output (I/O) frequency. However, such related art methods do not consider volume service levels. The related art implementations may thereby move volumes with a high service level that would not be maintained at their specified high service level if they were moved to the cloud, thereby causing a service level violation. It is difficult to manually conduct a stable operation while considering storage systems conditions which changes with every moment.

Therefore, the challenge is to decide automatically which data to move to the cloud to minimize the service level impact.

### SUMMARY

Example implementations described herein allow the IT administrators with limited expertise to maintain storage systems with minimum impact to the service level.

Aspects of the present disclosure can involve an apparatus connected to another storage system, involving one or more volumes, each of the one or more volumes associated with importance information, the one or more volumes stored across one or more components to facilitate data redundancy, the importance information indicative of whether data of the one or more volumes can be stored in the apparatus or the another storage system; and a processor, configured to, for a detection of a failure of a component from the one or more components, determine an amount of free space required to restore redundancy from an amount of data stored in the failed component; determine ones of the one or more volumes that can be migrated to the another storage system based on the importance information indicating that data of the determined ones of the one or more volumes can be stored in the another storage system; determine a combination of the determined ones of the one or more volumes that satisfy the amount of free space required based on capacity information of the determined ones of the one or more volumes; and migrate the determined combination of the determined ones of the one or more volumes to the another storage system to restore redundancy. Such an apparatus can be a server or a storage device system, in accordance with a desired implementation.

Aspects of the present disclosure can involve a system connected to another storage system, involving one or more volumes, each of the one or more volumes associated with importance information, the one or more volumes stored across one or more components to facilitate data redundancy, the importance information indicative of whether data of the one or more volumes can be stored in the apparatus or the another storage system; and for a detection of a failure of a component from the one or more components, means for determining an amount of free space required to restore redundancy from an amount of data stored in the failed component; means for determining ones of the one or more volumes that can be migrated to the another storage system based on the importance information indicating that data of the determined ones of the one or more volumes can be stored in the another storage system; means for determining a combination of the determined ones of the one or more volumes that satisfy the amount of free space required based on capacity information of the determined ones of the one or more volumes; and means for migrating the determined combination of the determined ones of the one or more volumes to the another storage system to restore redundancy.

Aspects of the present disclosure can involve a method for an apparatus connected to another storage system, involving one or more volumes, each of the one or more volumes associated with importance information, the one or more volumes stored across one or more components to facilitate data redundancy, the importance information indicative of whether data of the one or more volumes can be stored in the apparatus or the another storage system; and for a detection of a failure of a component from the one or more components, the method involving determining an amount of free space required to restore redundancy from an amount of data stored in the failed component; determining ones of the one or more volumes that can be migrated to the another storage system based on the importance information indicating that data of the determined ones of the one or more volumes can be stored in the another storage system; determining a combination of the determined ones of the one or more volumes that satisfy the amount of free space required based on capacity information of the determined ones of the one or more volumes; and migrating the determined combination of the determined ones of the one or more volumes to the another storage system to restore redundancy.

Aspects of the present disclosure can involve a computer program, storing instructions for an apparatus connected to another storage system, involving one or more volumes, each of the one or more volumes associated with importance information, the one or more volumes stored across one or more components to facilitate data redundancy, the importance information indicative of whether data of the one or more volumes can be stored in the apparatus or the another storage system; and for a detection of a failure of a component from the one or more components, the instructions involving determining an amount of free space required to restore redundancy from an amount of data stored in the failed component; determining ones of the one or more volumes that can be migrated to the another storage system based on the importance information indicating that data of the determined ones of the one or more volumes can be stored in the another storage system; determining a combination of the determined ones of the one or more volumes that satisfy the amount of free space required based on capacity information of the determined ones of the one or more volumes; and migrating the determined combination of the determined ones of the one or more volumes to the another storage system to restore redundancy. The computer program and instructions can be stored on a non-transitory computer readable medium and executed by one or more processors.

### BRIEF DESCRIPTION OF DRAWINGS

FIG. 1 illustrates an example related art implementation to move data to the cloud.

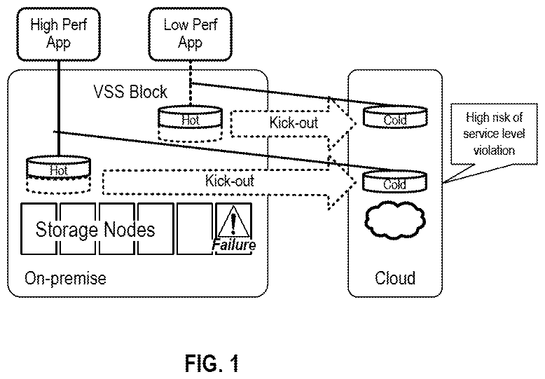

FIG. 2 illustrates an example of volume provisioning, in accordance with an example implementation.

FIG. 3 illustrates an example of storage system management operation, in accordance with an example implementation.

FIG. 4 illustrates an example of the overall system structure, in accordance with an example implementation.

FIG. 5 illustrates an example use case diagram for Storage Management Service, in accordance with an example implementation.

FIG. 6 illustrates an example interface of the storage resource database, in accordance with an example implementation.

FIG. 7 illustrates an example interface for the Service Catalog, in accordance with an example implementation.

FIG. 8 illustrates an example of the volume creation user interface, in accordance with an example implementation.

FIG. 9 illustrates an example of a kick-out and reallocation, in accordance with an example implementation.

FIG. 10 illustrates an example flow for calculating the extent of capacity shortages and reallocation patterns, in accordance with an example implementation.

FIG. 11 illustrates an example flow for calculating the extent of the capacity shortage, in accordance with an example implementation.

FIG. 12 illustrates an example flow for determining whether the capacity is sufficient, in accordance with an example implementation.

FIG. 13 illustrates an example flow for determining whether kick-out is needed, in accordance with an example implementation.

FIG. 14 illustrates an example flow for calculating the reallocation pattern, in accordance with an example implementation.

FIG. 15 illustrates an example flow for determining volumes to be kicked out, in accordance with an example implementation.

FIG. 16 illustrates an example flow for reallocating resources, in accordance with an example implementation.

FIG. 17 illustrates another example implementation in which performance is considered.

FIG. 18 illustrates another example implementation in which more on-premise resources are utilized.

FIG. 19 illustrates an example flow for determining whether the on-premise storage has capacity to accept more volumes, in accordance with an example implementation.

FIG. 20 illustrates an example flow to prioritize on-premise resources, in accordance with an example implementation.

FIG. 21 illustrates an example of providing a suggestion to add resources to the on-premise storage to return volumes to the on-premise storage, in accordance with an example implementation.

FIG. 22 illustrates an example computing environment with an example computer device suitable for use in some example implementations.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

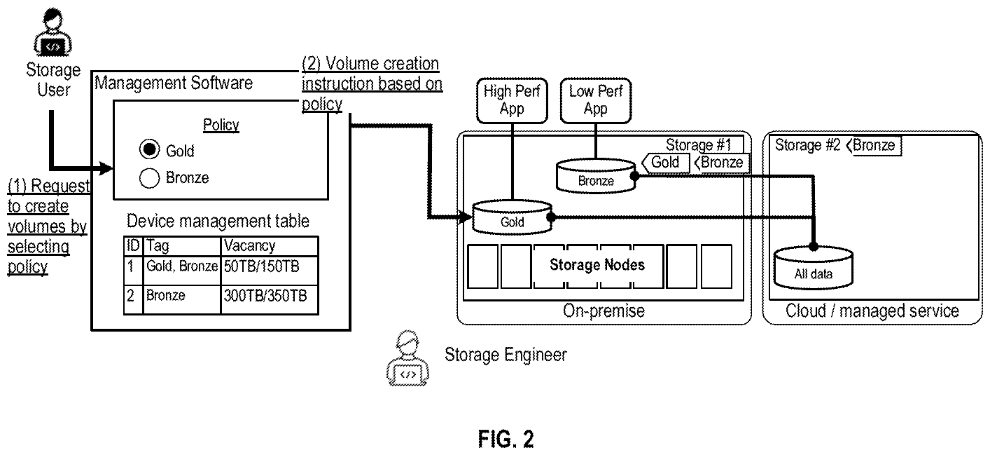

FIG. 2 illustrates an example of volume provisioning, in accordance with an example implementation. Example implementations described herein add importance information to the volumes. Importance can be determined based on a desired factor such as service level (e.g., gold is high importance, bronze is low importance). Example implementations further determine the storage to be deployed based on the importance of the volume.

In the example of FIG. 2, there are two steps used for the volume provisioning. In the first step (1), a storage user submits a request to create volumes by selecting a policy through the management software. The importance of the volume to be created is determined based on service level. In the example of FIG. 2, gold has a higher importance than bronze. In the second step (2), the management software selects the storage that is used to deploy volumes. To select storage devices, the management software uses tags. Tags indicate the types of volumes that are accepted by the storage device (e.g., Storage device #1 can accept gold or bronze). Tags are assigned to storage devices by storage engineers.

The management software has a device management table which has relationship between tags and storage devices. In the example of FIG. 2, there are two storage devices, storage device #1, and storage device #2. Storage device #1 has two tags, Gold and Bronze, and can accept volumes with the gold policy and volumes with the bronze policy. Storage device #2 has one tag, Bronze, and can accept volumes with the bronze policy.

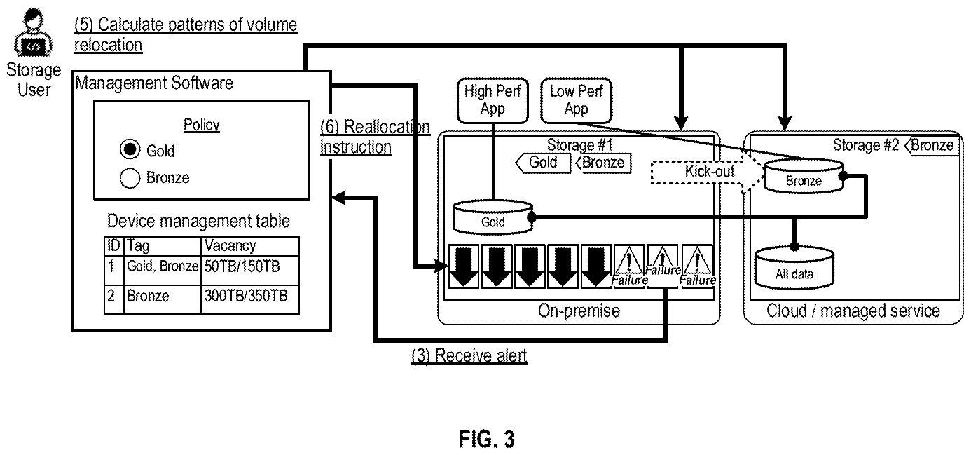

FIG. 3 illustrates an example of storage system management operation, in accordance with an example implementation. As shown in FIG. 3, the management software, while in operation, detects an issue such as a device failure through receipt of an alert or based on monitoring the storage systems. In the example of FIG. 3, device failure is used as an example, and the management software receives a corresponding alert at a third step (3).

At a fourth step (4), when the management software detects an issue, the management software requests a volume migration to storage devices based on a pre-calculated pattern. At a fifth step (5), after the migration, the management software request to reallocate resources based on pre-calculated pattern to storage devices. At a sixth step (6), the management software calculates the extent of capacity shortage and reallocation patterns.

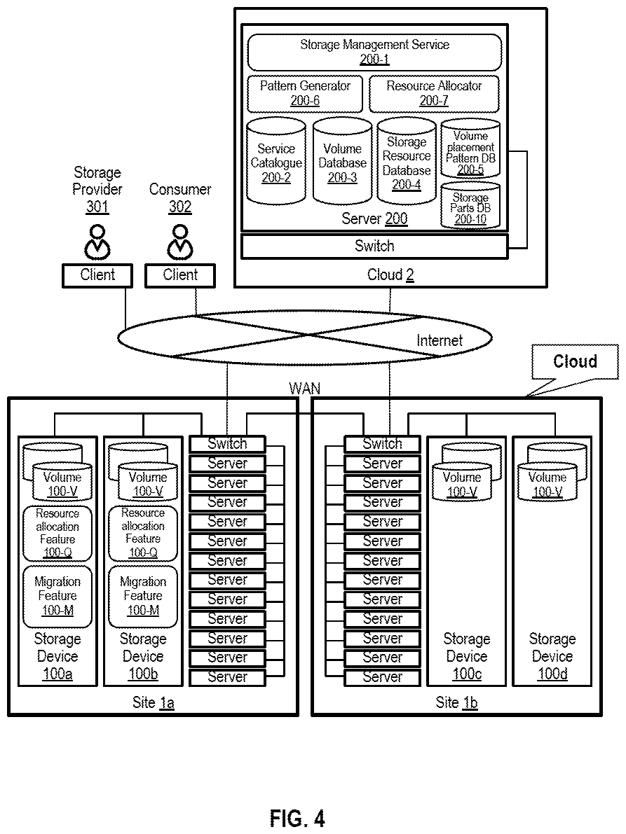

FIG. 4 illustrates an example of the overall system structure, in accordance with an example implementation. The system includes multiple sites 1a, 1b and Cloud 2. These connect to each other via network (e.g. internet). Storage provider 301 manages the system for providing storage services, and Consumer 302 operates the storage services over network. The storage service application, which provides storage services at sites 1a and 1b, runs on a Server 200 on Cloud 2. The storage service application involves the storage management service 200-1 and databases as follows.

Service Catalogue 200-2 stores a list of services and their settings provided by Provider 301 to Consumer 302. Volume Database 200-3 stores a list of volumes provided by the storage devices. Storage Resource Database 200-4 stores a list of resources that Storage Devices 100a-100d can provide. Volume placement pattern database 200-5 stores the relationship of the pattern and the current parts of the storage to determine volume migration. Pattern generator 200-6 generates patterns that can occur. Resource allocator 200-7 is configured to allocate resources from the sites 1a, 1b, through instructions. Storage parts database 200-10 indicate which portions of the storage devices 100a-100d correspond to which tier of volume.

Site 1a and 1b are connected by a network (e.g. Wide Area Network). Each site has computer servers and switches. Site 1a has Local Storage Devices 100a, 100b, and Site 1b has Remote Storage Devices 100c, and 100d. These are connected by LAN (Local Area Network) and/or SAN (Storage Area Network).

Some virtual machines, containers, and applications run on servers and their data is stored on Local Storage Device 100a, 100b. Storage devices 100a, 100b has associated volumes 100-V, migration features 100-M and resource allocation features 100-Q.

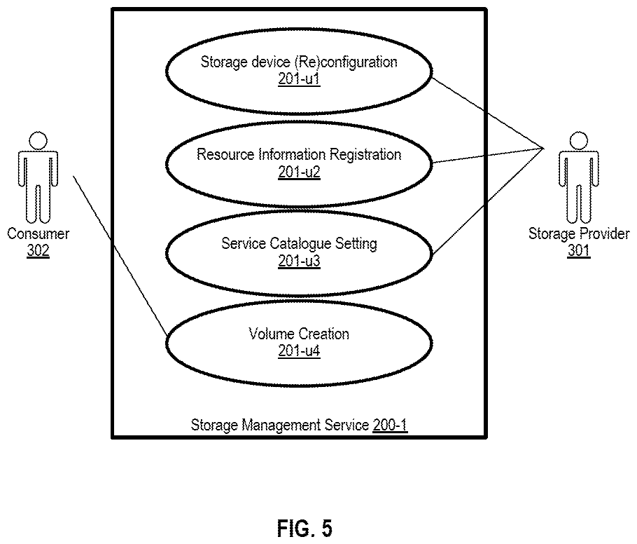

FIG. 5 illustrates an example use case diagram for Storage Management Service 200-1, in accordance with an example implementation. Storage provider 301 manages the following functions.

Storage device (re)configuration 201-u1: Storage provider 301 performs drive installation on storage devices, pool configuration, network configuration for hosts, and so on. It may be reconfigured as system requirements change.

Resource Information Registration 201-u2: Storage provider 301 registers available capacity, capacity threshold, and so on. This operation can be done by automatic generation from the system configuration, rather than manual input by the provider. Storage Provider 301 will change parameters when there is a change in system.

Service catalogue setting 201-u3 is a catalogue of the available services set by the storage provider 301.

Volume creation 201-u4 is a function used by the consumer to create a volume.

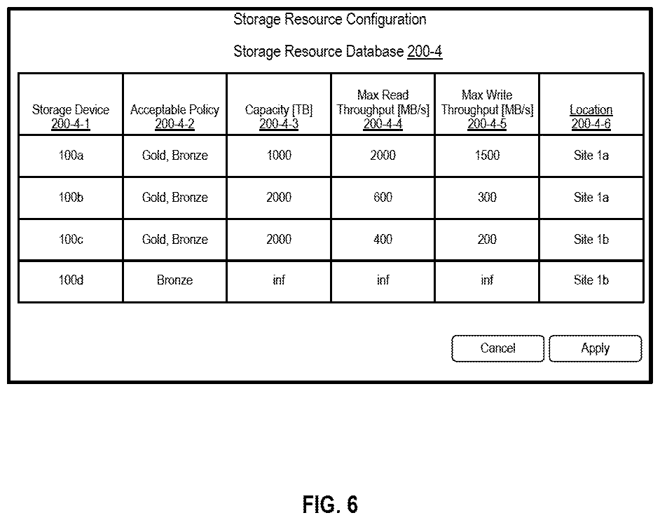

FIG. 6 illustrates an example interface of the storage resource database 200-4, in accordance with an example implementation. Specifically, the storage resource database 200-4 manages the storage resource configuration of the storage devices. FIG. 6 illustrates an example interface that can be provided when Storage Provider 301 executes Storage device (Re)configuration 201-u1 from the Storage Management Service 200-1. This screen displays the information stored in Storage Resource Database 200-4 and accepts edits to facilitate the desired implementation.

The fields can include the storage device 200-4-1, acceptable policy 200-4-2, capacity 200-4-3, maximum read throughput 200-4-4, maximum write throughput 200-4-5, and location 200-4-6. Storage device 200-4-1 is a field for the identifier of the storage device. Acceptable policy 200-4-2 indicates the acceptable policies that can be stored into the storage device. Capacity 200-4-3 indicates the storage capacity of the storage device. Max read throughput 200-4-4 indicates the maximum read throughput available for the storage device. Max write throughput 200-4-4 indicates the maximum write throughput available for the storage device. Location 200-4-6 indicates the site in which the storage device is located.

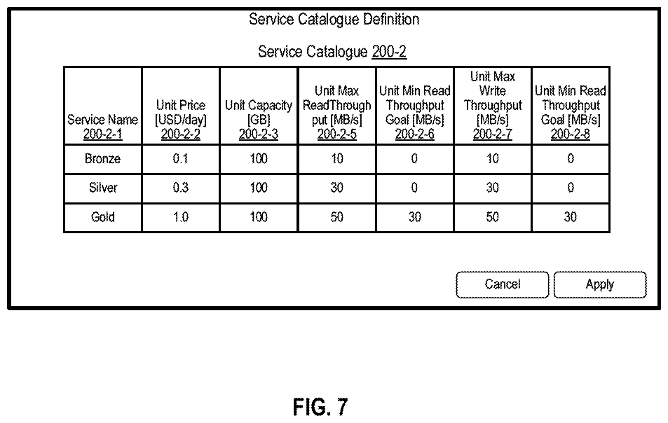

FIG. 7 illustrates an example interface for the Service Catalog 200-2, in accordance with an example implementation. The image of FIG. 7 is an example interface image that Storage Management Service 200-1 displays to Storage Provider 201 for Service Catalogue Setting 201-u3. This screen displays the information stored in 200-2 and accepts edits to facilitate the desired implementation.

Service Catalogue 200-2 manages the list of storage volume provisioning services tied to the Service Name 200-2-1, and includes the Unit Price 200-2-2, Unit Capacity 200-2-3, Unit Maximum Read Throughput 200-2-5, Unit Minimum Read Throughput Goal 200-2-6, Unit Maximum Write Throughput 200-2-7, and Unit Minimum Write Throughput Goal 200-2-8.

Service Name 200-2-1 is a unique name in the system. Unit Price 200-2-2 indicates the cost that will be incurred when one unit of the service is purchased. Unit Capacity 200-2-3 indicates the capacity that will be provided when one unit of the service is purchased. Unit Maximum Read Throughput 200-2-5 indicates the maximum read throughput available for the service. Unit Minimum Read Throughput Goal 200-2-6 indicates the minimum read throughput available for the service. Unit Maximum Write Throughput 200-2-7 indicates the maximum write throughput for the service. Unit Minimum Write Throughput Goal 200-2-8 indicates the target minimum write throughput to be achieved.

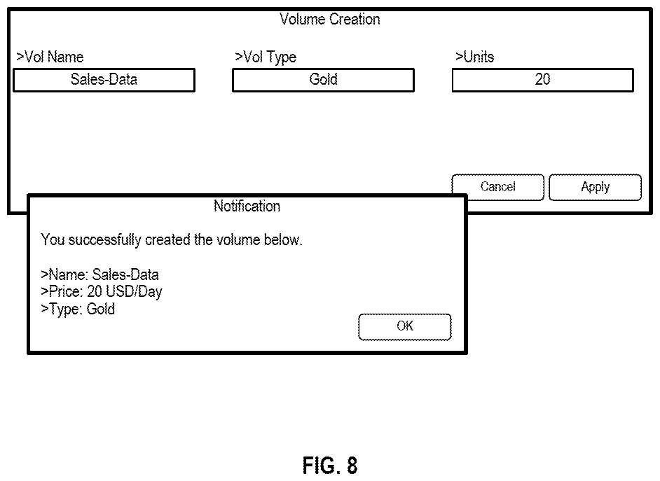

FIG. 8 illustrates an example of the volume creation user interface, in accordance with an example implementation. As shown in FIG. 8, volume creation user interface is invoked when the consumer 302 executes the Volume Creation 201-u4 as illustrated in FIG. 5. Volume creation user interface can receive fields such as volume name, volume type, and number of units. Once applied, then a notification can be provided to indicate the name of the volume, the price of the volume, and the type of the volume.

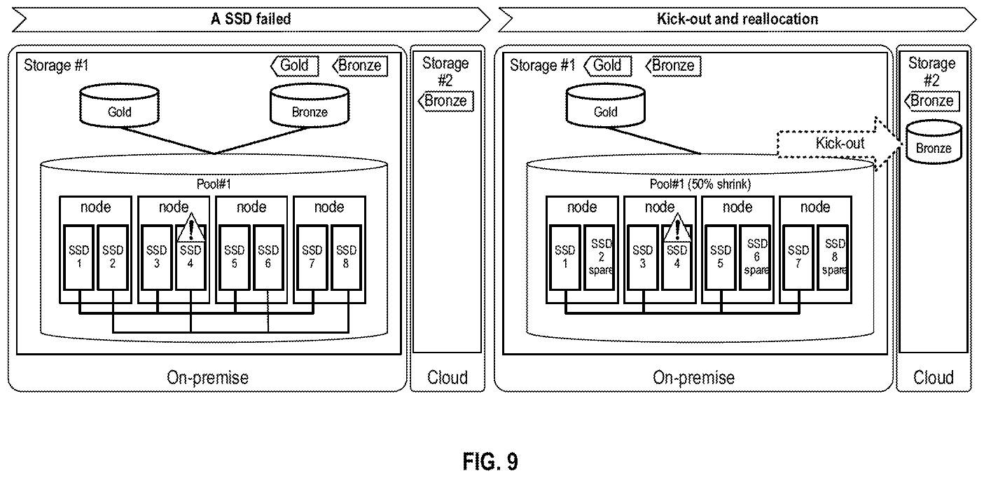

FIG. 9 illustrates an example of a kick-out and reallocation, in accordance with an example implementation. The kick-out and reallocation process can be invoked when there the Storage Provider 301 executes a Storage device (Re)configuration 201-u1. In the example of FIG. 9, suppose there are two storage devices, storage #1 and storage #2. Storage #1 is assigned Gold and Bronze tags, with two types of volumes (Gold and Bronze) created from pool #1. Pool #1 is formed from four storage nodes, each of the nodes having two solid state drives (SSDs) and involving two RAID (redundant array of inexpensive disks) groups. Gold and Bronze volume use the same capacity of the RAID groups. Both RAID groups are set at a parity of 1 so that they can accept one SSD failure from among all the SSDs in the RAID group.

Storage #2 is assigned the Bronze tag and is in the cloud. Due to its status in the cloud, for purposes of this example Storage #2 is presumed to have unlimited resources.

In this example, suppose that SSD #4 fails, thereby degrading redundancy in the corresponding RAID group. The RAID group involving SSD #4 does not have any spare SSDs, so the RAID group cannot be recovered. Accordingly, if another SSD in that RAID group fails, gold and bronze volume will be lost.

In the example of FIG. 9, it is determined that Storage #1 can hold the capacity of the gold volume, and Storage #2 has sufficient capacity to accept a bronze volume and has sufficient capacity to host the bronze volume. In this example, the bronze volume is then subject to kick-out, meaning that the bronze volume is migrated to the cloud to make capacity available for the gold volume. After the kick-out occurs, all of the data in the gold volume is merged to the unaffected RAID group in a reallocation. The degraded RAID group is then turned into spare volumes for the unaffected RAID group.

After the reallocation, the capacity of Pool #1 shrinks 50% because pool #1 has only one RAID group. In the example implementations described herein, the kick-out and reallocation is conducted with a pre-calculated pattern.

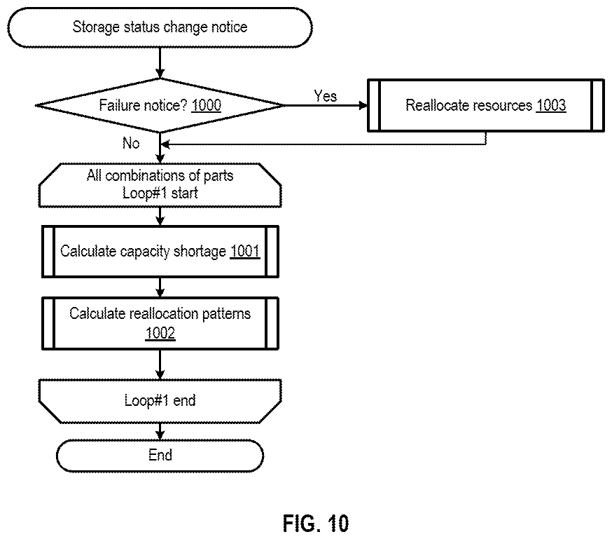

FIG. 10 illustrates an example flow for calculating the extent of capacity shortages and reallocation patterns, in accordance with an example implementation. Reallocation patterns are calculated every time the status of a storage device changes. Status can change based on an addition of an SSD, addition of a storage node, creation of a volume, a hardware failure, and so on. When the management software receives a failure notice, an acceptable pattern from pre-calculated patterns is found and resources are reallocated accordingly. After reallocation, the management software calculates new patterns of reallocation for all combinations of existing parts.

At 1000, a determination is made as to whether the storage status change was provoked based on a failure notice. If so (Yes), then the flow proceeds to 1003 to reallocate resources according to a sub-routine. Otherwise (No), a loop is initiated to iteratively calculate the capacity shortage 1001 and calculate the reallocation patterns 1002.

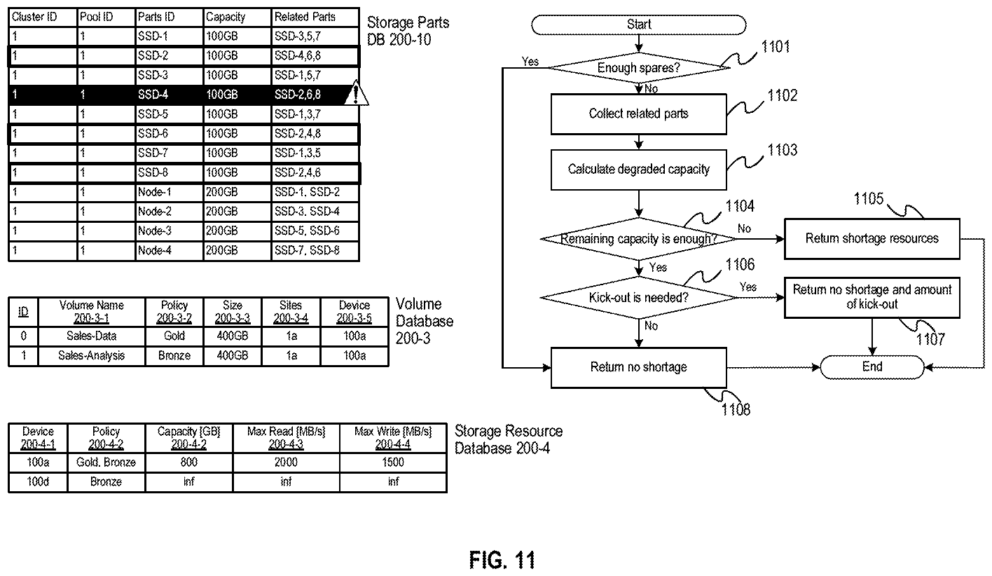

FIG. 11 illustrates an example flow for calculating the extent of the capacity shortage 1001, in accordance with an example implementation. The flow for FIG. 11 is described with respect to the Storage Parts DB 200-10, the Volume Database 200-3, and the Storage Resource Database 200-4 to calculate the failure pattern described in FIG. 9.

Volume Database 200-3 is a database for managing information on storage system configurations and resources managed by the storage service. Fields can include Volume Name 200-3-1, Policy 200-3-2, size 200-3-3, the sites of the storage of the volume 200-3-4, and the name of the storage device where the volume was created 200-3-5, as created by Consumer 302 through volume creation operations as illustrated in FIG. 8.

At 1101, a check is made as to whether there are sufficient spare storage devices. If not (No), then the flow proceeds to step 1102, otherwise (Yes) the flow proceeds to 1108. In this example, there are no spares

At 1102, the flow collects related parts by referencing the Storage Parts DB 200-10. In referencing the Storage Parts DB 200-10, a determination is made that if SSD-4 fails as illustrated in FIG. 9, then the related parts are SSD-2, 6, 8 (the SSDs in the RAID group).

At 1103, the flow calculates degraded capacity by using related parts. Per the Storage Parts DB 200-10, if the SSD-4 fails, the degraded capacity is 400 GB because SSD-4 itself has 100 GB and related parts SSD-2, 6, 8 have 100 GB respectively.

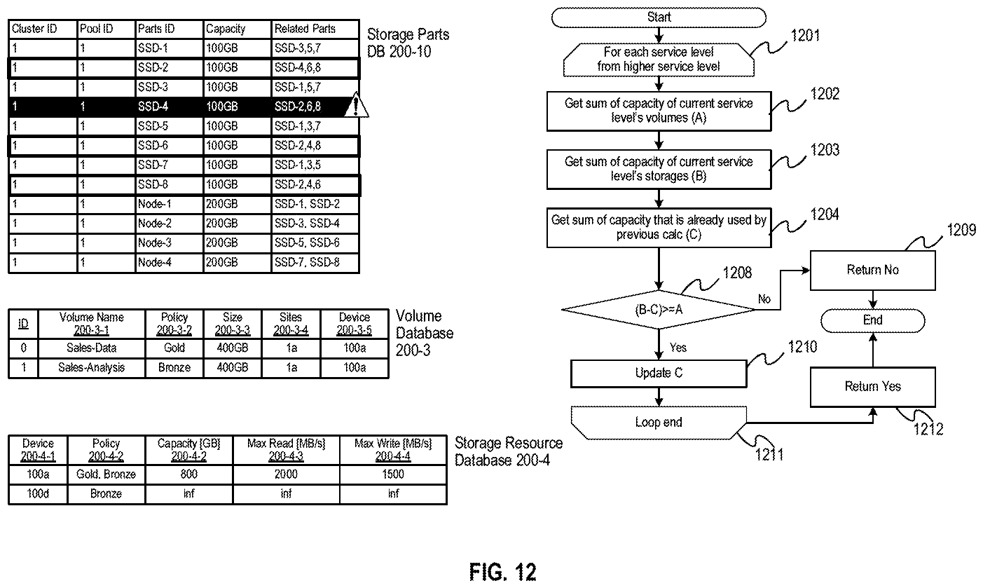

At 1104, a check is made as to whether the remaining capacity is enough. The flow to check for the sufficiency of the remaining capacity is described with respect to FIG. 12. If not (No), then the flow proceeds to 1105 to return the shortage resources.

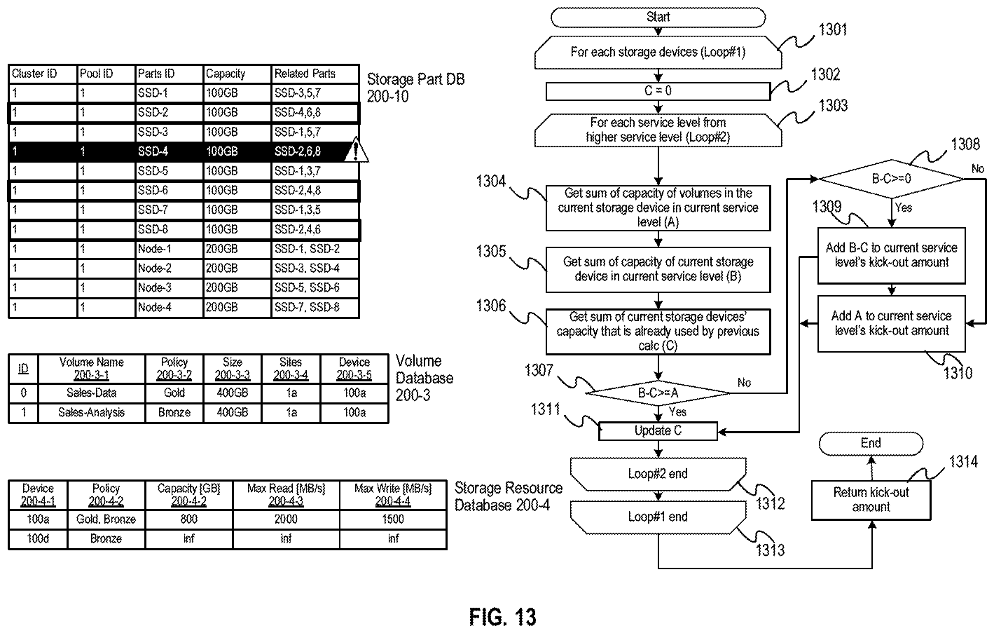

At 1106, a check is made as to whether a kick-out is needed. The check for the need for a kick-out is described with respect to FIG. 13. If not (No) then the flow proceeds to 1108, otherwise (Yes) the flow proceeds to 1107 to return no shortage and amount of kick-out.

FIG. 12 illustrates an example flow for determining whether the capacity is sufficient, in accordance with an example implementation. The flow for FIG. 12 is described with respect to the Storage Parts DB 200-10, the Volume Database 200-3, and the Storage Resource Database 200-4 for the failure pattern described in FIG. 9.

At 1201, a loop is initiated for each service level from the higher service level. In this example, Gold is used. At 1202, the flow obtains the sum of the capacity of current service level's volumes and let (A) be the sum. As for gold, A is 400 GB. At 1203, the flow obtains the sum of the capacity of current service level's storages and let (B) the sum. As for gold, B is 400 GB, because storage device 100a is the only storage device that can serve gold volumes. The maximum capacity of 100a is 800 GB per the Storage Resource Database 200-4. Storage Device 100a has a degraded capacity of 400 GB, 800 GB−400 GB=400 GB, so B is 400 GB.

At 1204, the flow obtains the sum of the capacity that is already used by previous calculation and let (C) be the sum. As for gold volume, C is 0.

At 1208, the flow checks if the available capacity for current service level is enough. The formula for available capacity is B-C>=A (available capacity). As for gold, B-C=400 GB, and A is 400 GB, so the flow proceeds to 1210 to Update C. Otherwise (No), the flow proceeds to 1209 to indicate that there is insufficient capacity. The loop ends at 1211, and the flow returns that there are sufficient resources at 1212.

FIG. 13 illustrates an example flow for determining whether kick-out is needed, in accordance with an example implementation. The flow for FIG. 13 is described with respect to the Storage Parts DB 200-10, the Volume Database 200-3, and the Storage Resource Database 200-4 for the failure pattern described in FIG. 9.

At 1301, a loop for each storage device is executed. This is because the kick-out amount is the capacity that must be moved to other storage devices.

At 1302, a loop for each service level is executed from the higher service level. In the example herein, Storage Device 100a and bronze is used as an example. The flow from 1304 to 1306 is the same as 1202 to 1204 of FIG. 12, but as applied to one storage device. In this example, A=400, B=400, and C=400.

At 1307, because B-C=0 and A=400 from the example of FIG. 9, the flow proceeds to 1308 (No). Otherwise (Yes) the flow proceeds to 1311 to update C.

At 1308, B-C=0 from the example of FIG. 9, so the flow proceeds to 1309. Otherwise, the flow proceeds to 1310.

At 1309 and 1310, the amount of B-C is added to the current service level's kick-out amount, and at 1310, A is added to the current service level's kick-out amount. The amount of kick-out is 400 because A=400, B-C=0.

The loops end at 1312 and 1313, and the kick-out amount is returned at 1314.

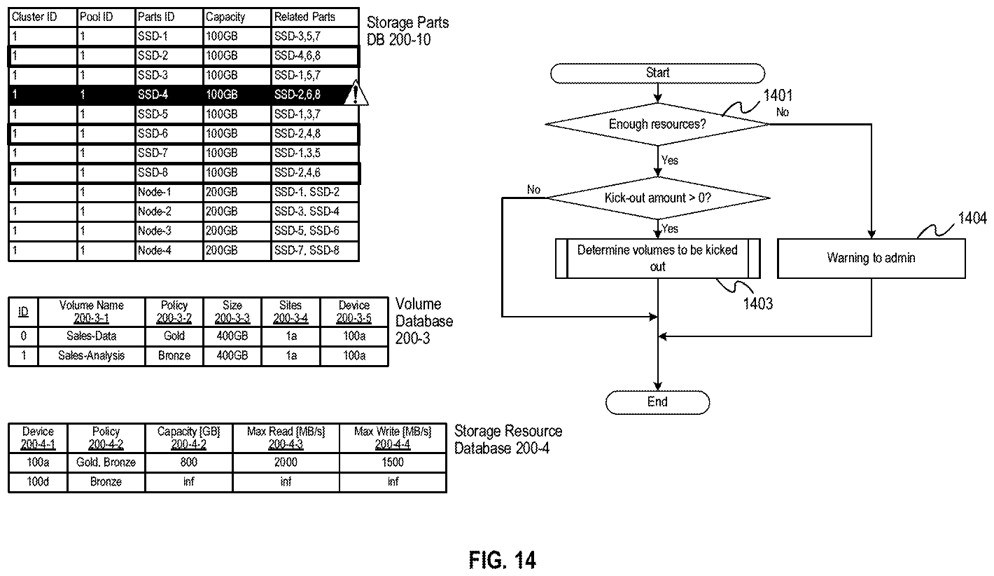

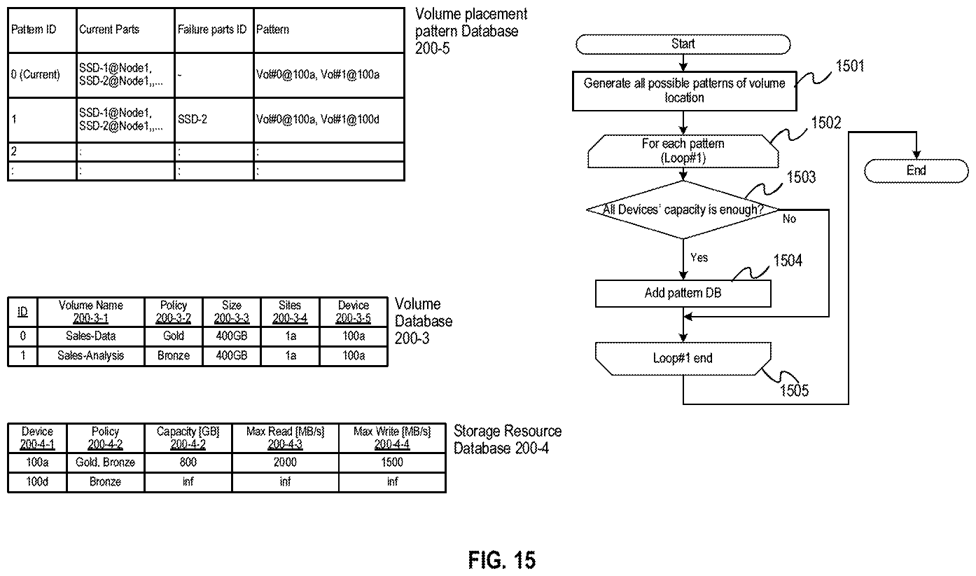

FIG. 14 illustrates an example flow for calculating the reallocation pattern, in accordance with an example implementation. The flow for FIG. 14 is described with respect to the Storage Parts DB 200-10, the Volume Database 200-3, and the Storage Resource Database 200-4 for the failure pattern described in FIG. 9. The flow at 1401 and 1402 are determined based on the execution of FIGS. 12 and 13, respectively. If there is not enough resources (No), a warning to the administrator is provided to 1404. The flow for determining the volumes to kick out at 1403 is described with respect to FIG. 15.

FIG. 15 illustrates an example flow for determining volumes to be kicked out, in accordance with an example implementation. The flow for FIG. 15 is described with respect to the Volume placement pattern Database 200-5, the Volume Database 200-3, and the Storage Resource Database 200-4 for the failure pattern described in FIG. 9. At 1501, the flow generates all possible patterns of the volume location. At 1502, the flow initiates a loop for each pattern. At 1503, for each volume location pattern, the flow checks if all storage devices' capacity is sufficient. If so (Yes), then the flow proceeds to 1504 to add the pattern to the database. At 1505, the loop ends.

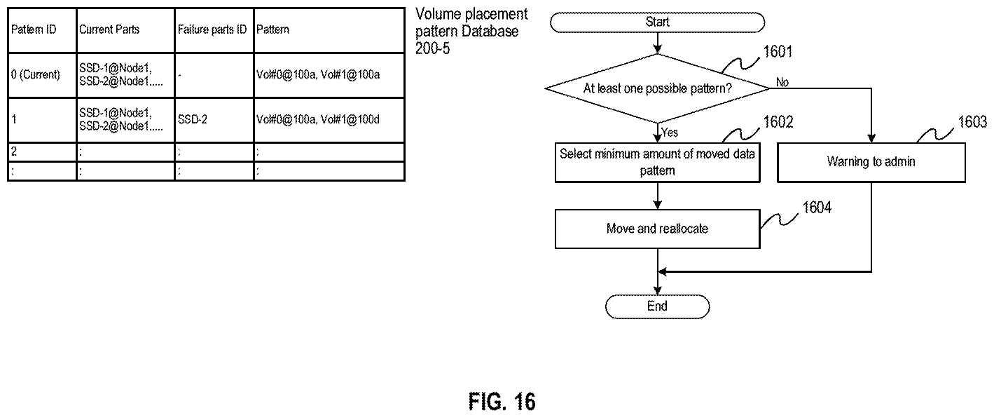

FIG. 16 illustrates an example flow for reallocating resources, in accordance with an example implementation. The example flow of FIG. 16 is based on the pattern of FIG. 9 and involves Volume placement pattern DB 200-5. If there is one possible pattern, the flow will select minimum amount of data to move. At 1601, the flow determines if there is at least one possible pattern. If not (No), then a warning is issued to the administrator at 1603, otherwise (Yes) the flow proceeds to 1602 to select the pattern that moves the minimum amount of data. At 1604, the pattern is executed to move and reallocate the data. The flow at 1602 can be modified in accordance with the desired implementation. For example, it can be to move the minimum amount of to the higher policy level.

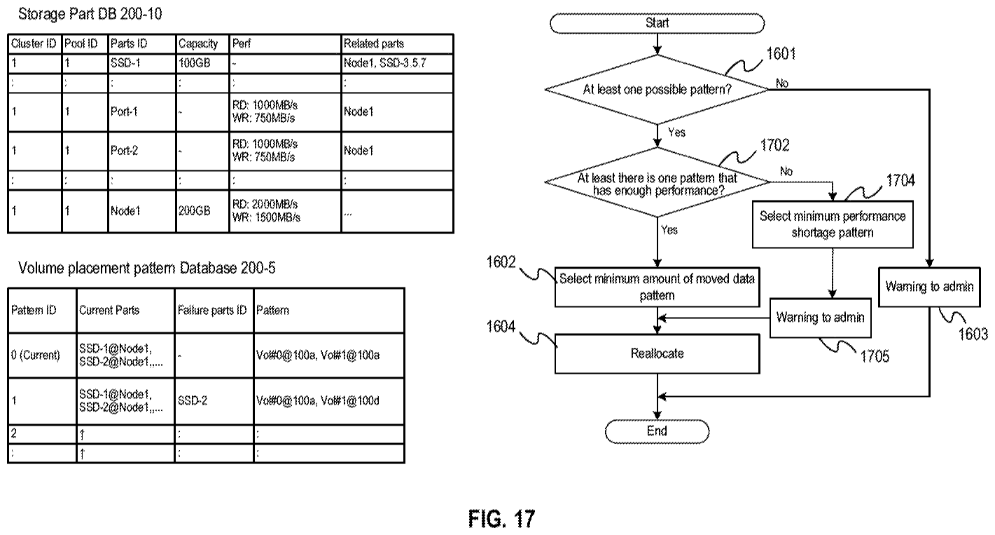

FIG. 17 illustrates another example implementation in which performance is considered. The flow is similar to FIG. 16, except that the flow at 1702, 1704, and 1705 are changed. In the flow of FIG. 16, the management software does not check for performance. However, in the example of FIG. 17, performance is used as a field in Storage Part DB 200-10. If the performance is insufficient, the management software will send an alert to admin regarding the performance issue, but will still reallocate.

As shown in FIG. 17, at 1702, a determination is made as to whether there is one pattern that has sufficient performance. If so (Yes), then the flow proceeds as in 1602, otherwise (No) the flow proceeds to 1704 to select the minimum performance shortage pattern and then sends a warning to the administrator at 1705.

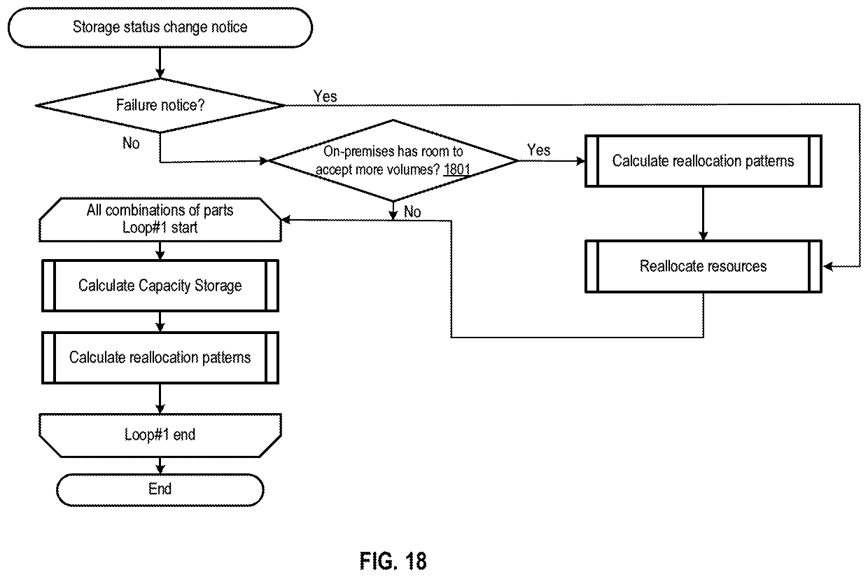

FIG. 18 illustrates another example implementation in which more on-premise resources are utilized. Reallocation patterns are calculated every time the status of the storage device changes as described above. In this example flow, more on-premise resources are utilized for the reallocation. If there is capacity to accept more volumes in on-premise, then on-premise storage is prioritized so as to achieve a higher return on investment. In the example from FIG. 10, the management software reallocates resources when it receives failure notice. In this example, at 1800, the management software reallocates resources when it receives failure notice or there is the capacity to accept more volumes in the on-premise storage.

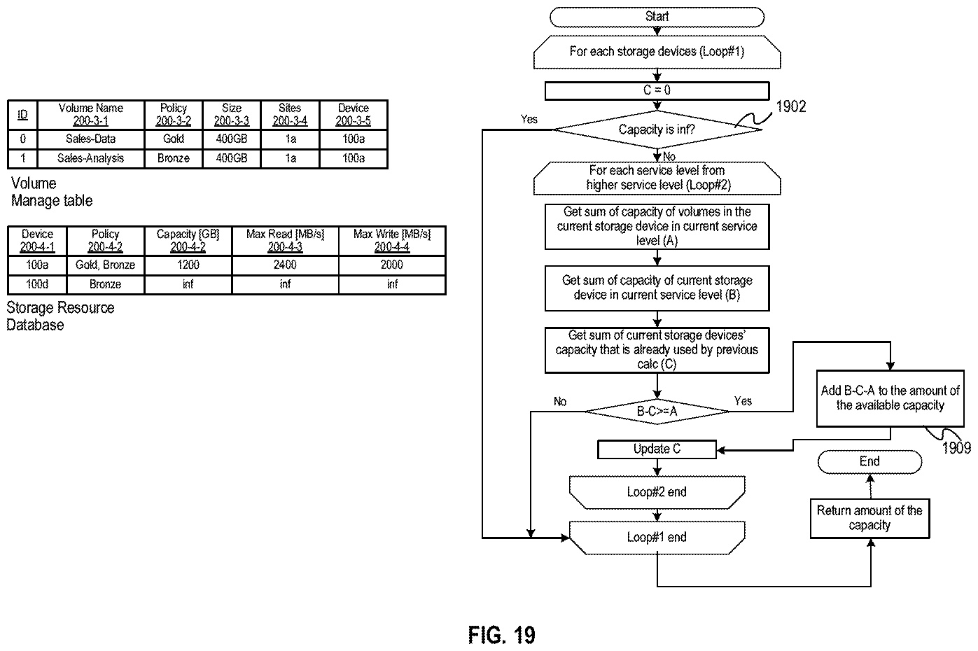

FIG. 19 illustrates an example flow for determining whether the on-premise storage has capacity to accept more volumes, in accordance with an example implementation. The flow is similar to FIG. 13, with the exceptions as shown at 1902 and 1909. At 1902, a determination is made as to whether capacity is infinity because the cloud is considered to have infinite capacity available, and is therefore skipped when calculating the available capacity of on-premise storage. At 1909, B-C-A is added to the amount of the available storage.

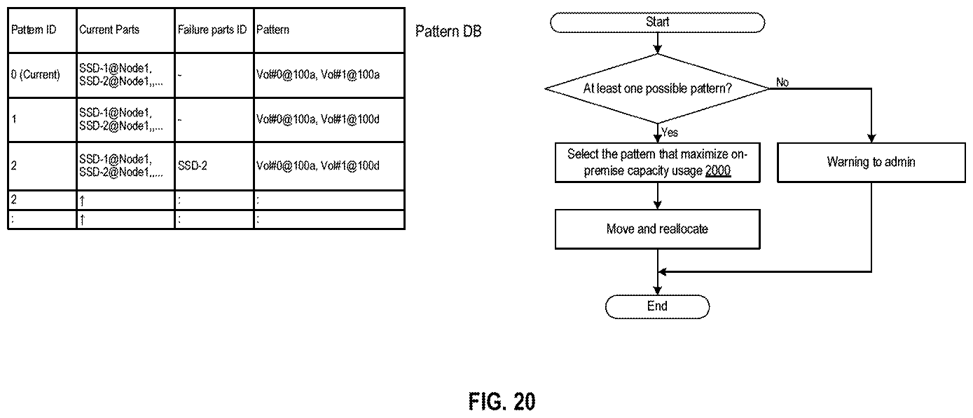

FIG. 20 illustrates an example flow to prioritize on-premise resources, in accordance with an example implementation. The flow is similar to FIG. 16, except at the flow of 2000 in which the pattern that manages on-premise capacity usage is utilized.

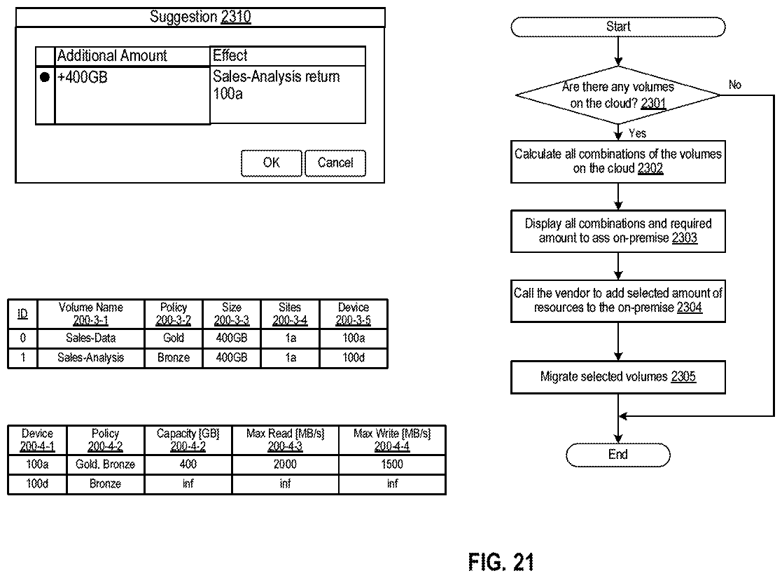

FIG. 21 illustrates an example of providing a suggestion to add resources to the on-premise storage to return volumes to the on-premise storage, in accordance with an example implementation. Depending on the desired implementation, the management software can conduct this sequence periodically to check if there are any volumes on the cloud 2301. If there are one or more volumes in the cloud, then the management software calculates all combinations of the volumes on the cloud at 2302 and provides the suggestions at 2303. In this example, Sales-analysis volume is on the cloud, then the management software displays its amount of capacity in suggestion window 2310. The management software receives the selection of the user, then it calls the vendor to add selected amount of resources to the on-premise at 2304. After resource addition, then the management software then migrates the selected volumes at 2305.

Through the example implementations described herein, it is thereby possible to prevent service level violations that could occur with kicking volumes out to the cloud, so a more stable operation can be maintained.

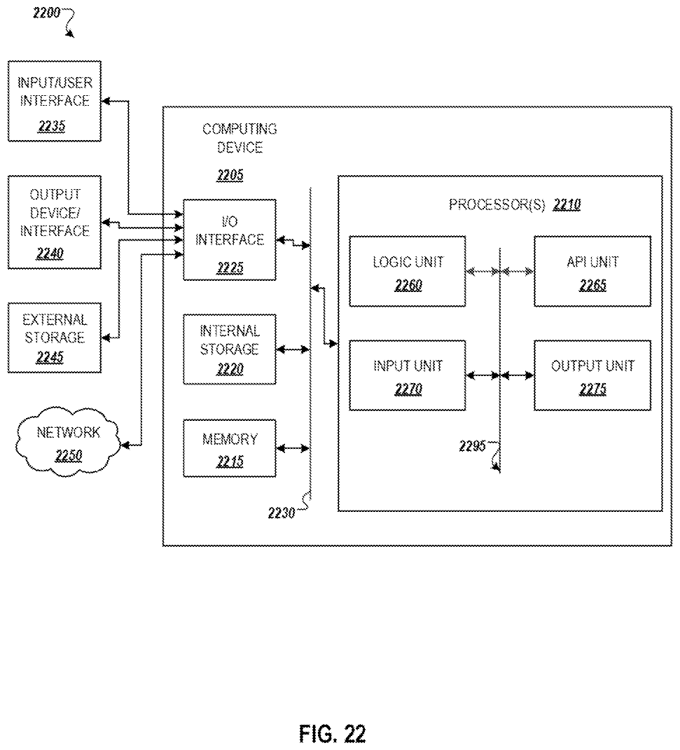

FIG. 22 illustrates an example computing environment with an example computer device suitable for use in some example implementations, such as a server 200 or a storage device 100a, 100b, 100c, 100d, that is connected to storage systems in sites 1a or 1b. Computer device 2205 in computing environment 2200 can include one or more processing units, cores, or processors 2210, memory 2215 (e.g., RAM, ROM, and/or the like), internal storage 2220 (e.g., magnetic, optical, solid state storage, and/or organic), and/or I/O interface 2225, any of which can be coupled on a communication mechanism or bus 2230 for communicating information or embedded in the computer device 2205. I/O interface 2225 is also configured to receive images from cameras or provide images to projectors or displays, depending on the desired implementation.

Computer device 2205 can be communicatively coupled to input/user interface 2235 and output device/interface 2240. Either one or both input/user interface 2235 and output device/interface 2240 can be a wired or wireless interface and can be detachable. Input/user interface 2235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2240 may include a display, television, monitor, printer, speaker, braille, or the like. In some example implementations, input/user interface 2235 and output device/interface 2240 can be embedded with or physically coupled to the computer device 2205. In other example implementations, other computer devices may function as or provide the functions of input/user interface 2235 and output device/interface 2240 for a computer device 2205.

Examples of computer device 2205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2205 can be communicatively coupled (e.g., via I/O interface 2225) to external storage 2245 and network 2250 for communicating with any number of networked components, devices, and systems, including one or more computer devices of the same or different configurations. Computer device 2205 or any connected computer device can be functioning as, providing services of, or referred to as a server, client, thin server, general machine, special-purpose machine, or another label.

I/O interface 2225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2200. Network 2250 can be any network or combination of networks (e.g., the Internet, local area network, wide area network, a telephonic network, a cellular network, satellite network, and the like).

Computer device 2205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 2210 can execute under any operating system (OS) (not shown), in a native or virtual environment. One or more applications can be deployed that include logic unit 2260, application programming interface (API) unit 2265, input unit 2270, output unit 2275, and inter-unit communication mechanism 2295 for the different units to communicate with each other, with the OS, and with other applications (not shown). The described units and elements can be varied in design, function, configuration, or implementation and are not limited to the descriptions provided. Processor(s) 2210 can be in the form of hardware processors such as central processing units (CPUs) or in a combination of hardware and software units.

In some example implementations, when information or an execution instruction is received by API unit 2265, it may be communicated to one or more other units (e.g., logic unit 2260, input unit 2270, output unit 2275). In some instances, logic unit 2260 may be configured to control the information flow among the units and direct the services provided by API unit 2265, input unit 2270, output unit 2275, in some example implementations described above. For example, the flow of one or more processes or implementations may be controlled by logic unit 2260 alone or in conjunction with API unit 2265. The input unit 2270 may be configured to obtain input for the calculations described in the example implementations, and the output unit 2275 may be configured to provide output based on the calculations described in the example implementations.

Processor(s) 2210 can be configured to manage one or more volumes, each of the one or more volumes associated with importance information (e.g., storage tier), the one or more volumes stored across one or more components to facilitate data redundancy (e.g., RAID groups), the importance information indicative of whether data of the one or more volumes can be stored in the apparatus (e.g., site 1a, cloud 2) or the another storage system (e.g., site 1b); and for a detection of a failure of a component from the one or more components, determine an amount of free space (e.g., capacity) required to restore redundancy from an amount of data stored in the failed component; determine ones of the one or more volumes that can be migrated to the another storage system based on the importance information indicating that data of the determined ones of the one or more volumes can be stored in the another storage system; determine a combination of the determined ones of the one or more volumes that satisfy the amount of free space required based on capacity information of the determined ones of the one or more volumes; and migrate the determined combination of the determined ones of the one or more volumes to the another storage system to restore redundancy. Through the example implementation described therein, is thereby possible to prevent service level violations that could occur with kicking volumes out to the cloud, so a more stable operation can be maintained.

Depending on the desired implementation, the importance information can involve a specified service level (e.g., gold, bronze) of the each of the one or more volumes.

Depending on the desired implementation, the importance information can involve a lower limit of volume performance required for the one or more volumes.

Processor(s) 2210 can be configured to execute the method or instructions as described above, wherein the processor(s) 2210 is configured to migrate the determined combination of the determined ones of the one or more volumes to the another storage system by migrating the determined ones of the one or more volumes in its entirety.

Processor(s) 2210 can be configured to execute the method or instructions as described above, wherein the processor(s) 2210 is configured to migrate the determined combination of the determined ones of the one or more volumes to the another storage system by migrating cold data (e.g., less used data) of the determined ones of the one or more volumes. In example implementations, the coldness of the data can be determined based on length of time since last read/write operation, or otherwise depending on the desired implementation.

Processor(s) 2210 can be configured to execute the method or instructions as described above, and be configured to determine ones of the one or more volumes that can be migrated to the another storage system based on the importance information by determining the ones of the one or more volumes associated with data indicated by the importance information being at a lower limit of required volume performance (e.g., based on throughput versus throughput goals as illustrated in FIG. 7).

Processor(s) 2210 can be configured to execute the method or instructions as described above, and be configured to determine the combination of the determined ones of the one or more volumes that satisfy the amount of free space required based on minimizing an amount of migrated data.

Processor(s) 2210 can be configured to execute the method or instructions as described above, and further be configured to determine the combination of the determined ones of the one or more volumes that satisfy the amount of free space required based on minimizing a number of migrated volumes.

Processor(s) 2210 can be configured to execute the method or instructions as described above, and further be configured to determine the combination of the determined ones of the one or more volumes that satisfy the amount of free space required based on minimizing an amount of migrated volumes that violate a service level specified in the importance information.

Processor(s) 2210 can be configured to execute the method or instructions as described above, and be further configured to determine the combination of the determined ones of the one or more volumes that satisfy the amount of free space required based on minimizing a number of volumes having insufficient performance according to the importance information.

Processor(s) 2210 can be configured to execute the method or instructions as described above, and be further configured to determine the combination of the determined ones of the one or more volumes that satisfy the amount of free space required based on the combination of the determined ones that maximize on-premise capacity usage.

Processor(s) 2210 can be configured to execute the method or instructions as described above, and be further configured to determine additional on-premise resources required to facilitate migration of the determined combination of the determined ones of the one or more volumes that satisfy the amount of free space required, and provide, through an interface, a suggestion to add the additional on-premise resources.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. An apparatus connected to another storage system comprising:
one or more volumes, each of the one or more volumes associated with importance information, the one or more volumes stored across one or more components to facilitate data redundancy, the importance information indicative of whether data of the one or more volumes can be stored in the apparatus or the another storage system;
a processor, configured to, for a detection of a failure of a component from the one or more components:
determine an amount of free space required to restore redundancy from an amount of data stored in the failed component;
determine ones of the one or more volumes that can be migrated to the another storage system based on the importance information indicating that data of the determined ones of the one or more volumes can be stored in the another storage system;
determine a combination of the determined ones of the one or more volumes that satisfy the amount of free space required based on capacity information of the determined ones of the one or more volumes; and
migrate the determined combination of the determined ones of the one or more volumes to the another storage system to restore redundancy.

2. The apparatus of claim 1, wherein the importance information comprises a specified service level of the each of the one or more volumes.

3. The apparatus of claim 1, wherein the importance information comprises a lower limit of volume performance required for the one or more volumes.

4. The apparatus of claim 1, wherein the processor is configured to migrate the determined combination of the determined ones of the one or more volumes to the another storage system by migrating the determined ones of the one or more volumes in its entirety.

5. The apparatus of claim 1, wherein the processor is configured to migrate the determined combination of the determined ones of the one or more volumes to the another storage system by migrating cold data of the determined ones of the one or more volumes.

6. The apparatus of claim 1, wherein the processor is configured to determine ones of the one or more volumes that can be migrated to the another storage system based on the importance information by determining the ones of the one or more volumes associated with data indicated by the importance information being at a lower limit of required volume performance.

7. The apparatus of claim 1, wherein the processor is configured to determine the combination of the determined ones of the one or more volumes that satisfy the amount of free space required based on minimizing an amount of migrated data.

8. The apparatus of claim 1, wherein the processor is configured to determine the combination of the determined ones of the one or more volumes that satisfy the amount of free space required based on minimizing a number of migrated volumes.

9. The apparatus of claim 1, wherein the processor is configured to determine the combination of the determined ones of the one or more volumes that satisfy the amount of free space required based on minimizing an amount of migrated volumes that violate a service level specified in the importance information.

10. The apparatus of claim 1, wherein the processor is configured to determine the combination of the determined ones of the one or more volumes that satisfy the amount of free space required based on minimizing a number of volumes having insufficient performance according to the importance information.

11. The apparatus of claim 1, wherein the processor is configured to determine the combination of the determined ones of the one or more volumes that satisfy the amount of free space required based on the combination of the determined ones that maximize on-premise capacity usage.

12. The apparatus of claim 1, wherein the processor is configured to determine additional on-premise resources required to facilitate migration of the determined combination of the determined ones of the one or more volumes that satisfy the amount of free space required, and
provide, through an interface, a suggestion to add the additional on-premise resources.

13. A method for an apparatus connected to another storage system comprising one or more volumes, each of the one or more volumes associated with importance information, the one or more volumes stored across one or more components to facilitate data redundancy, the importance information indicative of whether data of the one or more volumes can be stored in the apparatus or the another storage system; the method comprising:
for a detection of a failure of a component from the one or more components:
determining an amount of free space required to restore redundancy from an amount of data stored in the failed component;
determining ones of the one or more volumes that can be migrated to the another storage system based on the importance information indicating that data of the determined ones of the one or more volumes can be stored in the another storage system;
determining a combination of the determined ones of the one or more volumes that satisfy the amount of free space required based on capacity information of the determined ones of the one or more volumes; and
migrating the determined combination of the determined ones of the one or more volumes to the another storage system to restore redundancy.

14. A non-transitory computer readable medium, storing instructions for an apparatus connected to another storage system comprising one or more volumes, each of the one or more volumes associated with importance information, the one or more volumes stored across one or more components to facilitate data redundancy, the importance information indicative of whether data of the one or more volumes can be stored in the apparatus or the another storage system; the instructions comprising:
for a detection of a failure of a component from the one or more components:
determining an amount of free space required to restore redundancy from an amount of data stored in the failed component;
determining ones of the one or more volumes that can be migrated to the another storage system based on the importance information indicating that data of the determined ones of the one or more volumes can be stored in the another storage system;
determining a combination of the determined ones of the one or more volumes that satisfy the amount of free space required based on capacity information of the determined ones of the one or more volumes; and
migrating the determined combination of the determined ones of the one or more volumes to the another storage system to restore redundancy.
